(19) United States
(12) Patent Application Publication
(10) Pub. No.: US 2026/0134811 A1
(43) Pub. Date: May 14, 2026

(54) DISPLAY PANEL AND DISPLAY DEVICE

(71) Applicant: Guangzhou China Star Optoelectronics Semiconductor Display Technology Co., Ltd., Guangzhou (CN)

(72) Inventors: Yoonsung UM, Guangzhou (CN); Hongyuan XU, Guangzhou (CN); Shan PU, Guangzhou (CN); Wenxue HUO, Guangzhou (CN); Miao LIN, Guangzhou (CN)

(73) Assignee: Guangzhou China Star Optoelectronics Semiconductor Display Technology Co., Ltd., Guangzhou (CN)

(21) Appl. No.: 19/315,627

(22) Filed: Aug. 31, 2025

(30) Foreign Application Priority Data
Nov. 12, 2024 (CN) 202411615747.8

(51) Int. Cl. G09G 3/20

(52) U.S. Cl. CPC G09G 3/2003; G09G 2300/0452; G09G 2310/08; G09G 2320/0242

(57) ABSTRACT

A display panel includes a plurality of sub-pixel groups having two sub-pixels of different colors, a plurality of scanning line groups, and a plurality of data lines. A first scanning line and a second scanning line of each of the plurality of scanning line groups are disposed on two sides of a corresponding row of sub-pixel groups. A plurality of data lines is disposed between two adjacent columns of sub-pixel groups. Each of the plurality of data lines is connected to one of the two sub-pixels in the adjacent two columns of sub-pixel groups. Each of the plurality of data lines is connected to the sub-pixels of a same color, and two adjacent ones of the plurality of data lines are connected to the sub-pixels of different colors.

### CROSS-REFERENCE TO RELATED APPLICATION

The present application claims priority to and the benefit of Chinese Patent Application No. 202411615747.8, filed on Nov. 12, 2024, the disclosure of which is incorporated herein by reference in its entirety.

### TECHNICAL FIELD

The present disclosure relates to display technologies, and in particular, to a display panel and a display device.

### BACKGROUND

In the Data Line Sharing (DLS) pixel architecture of the current display panel, two columns of sub-pixels of different colors share one data line, reducing the number of data lines. However, a row of sub-pixels requires two scanning lines to drive, increasing the number of scanning lines, which reduces the charging time of the sub-pixels by half, resulting in color mixing on the display panel.

### SUMMARY

The present application provides a display panel and a display device to alleviate an issue of color mixing in the current display panel.

The technical proposal provided by the present application is as follows:
the present application provides a display panel, and the display panel includes□
a plurality of sub-pixel groups arranged along a first direction and a second direction, each of the plurality of sub-pixel groups comprising two sub-pixels of different colors arranged along the first direction;
a plurality of scanning line groups arranged along the second direction, each of the plurality of scanning line groups comprising a first scanning line and a second scanning line respectively extending along the first direction, and the first scanning line and the second scanning line being disposed on two sides of a corresponding row of the sub-pixel groups, and the first scanning line being connected to one of the two sub-pixels of each of the sub-pixel groups in one row, and the second scanning line being connected to the other one of the two sub-pixels of each of the sub-pixel groups in the row; and
a plurality of data lines extending along the second direction, and each of the plurality of data lines being arranged between two adjacent columns of the sub-pixel groups, and each of the plurality of data lines being connected to one of the two sub-pixels of each of the sub-pixel groups in the two adjacent columns;
wherein each of the plurality of data lines is connected to respective sub-pixels of a same color, and two adjacent ones of the plurality of data lines are connected to respective sub-pixels of different colors.

The present application further provides a display device, and the display device includes:
a plurality of sub-pixel groups arranged along a first direction and a second direction, each of the plurality of sub-pixel groups comprising two sub-pixels of different colors arranged along the first direction;
a plurality of scanning line groups arranged along the second direction, each of the plurality of scanning line groups comprising a first scanning line and a second scanning line respectively extending along the first direction, and the first scanning line and the second scanning line being disposed on two sides of a corresponding row of the sub-pixel groups, and the first scanning line being connected to one of the two sub-pixels of each of the sub-pixel groups in one row, and the second scanning line being connected to the other one of the two sub-pixels of each of the sub-pixel groups in a same or a different one row; and
a plurality of data lines extending along the second direction, and each of the plurality of data lines being arranged between two adjacent columns of the sub-pixel groups, and each of the plurality of data lines being connected to one of the two sub-pixels of each of the sub-pixel groups in the two adjacent columns;
wherein each of the plurality of data lines is connected to respective sub-pixels of a same color, and two adjacent ones of the plurality of data lines are connected to respective sub-pixels of different colors.

Other features and advantages of the present application will be described in detail in the detailed description that follows.

### BRIEF DESCRIPTION OF THE DRAWINGS

To provide a clearer explanation of the technical proposals presented in the embodiments of the present application, a brief introduction to the drawings required for the description of the embodiments is provided below. It is evident that the drawings described below are merely some embodiments of the present application. For those skilled in the art, other drawings can also be derived from these drawings without creative efforts.

To more fully understand the present application and beneficial effects of the present application, the following description is provided along with the accompanying drawings, and like reference numerals in the description denote like parts.

FIG. 1 is a simplified diagram of a structure of a display panel provided in an embodiment of the present application;

FIG. 2 is a first structural diagram of area M in FIG. 1 provided in an embodiment of the present application;

FIG. 3 is a timing diagram of the scanning lines in FIG. 2;

FIG. 4 is a second structural diagram of area M in FIG. 1 provided in an embodiment of the present application;

FIG. 5 is a third structural diagram of area M in FIG. 1 provided in an embodiment of the present application.

### DETAILED DESCRIPTION

The technical proposals in the embodiments of the present application will be clearly and completely described according to the accompanying drawings in the embodiments of the present application. The described embodiments are only some of the embodiments of the present application, rather than all the embodiments. Based on the embodiments in the application, all other embodiments obtained by those skilled in the field without making creative efforts fall within the scope of protection of the application.

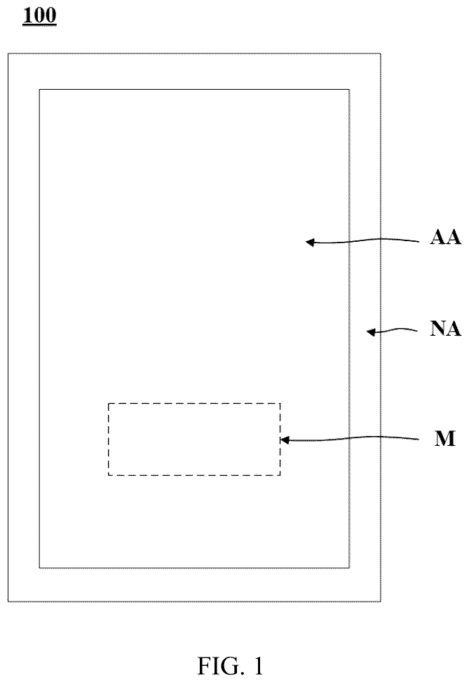

Referring to FIGS. 1 to 5, a display panel 100 is provided in an embodiment of the present application, and the display panel 100 includes a pixel region AA and a non-pixel region NA disposed on a side of the pixel region AA. The pixel region AA may be an area for performing display functions, and the non-pixel region NA may be a bezel area of the display panel 100.

In the embodiment, the pixel region AA includes a plurality of sub-pixel groups 10, a plurality of gate line groups 20, and a plurality of data lines Data.

In the embodiment, the plurality of the sub-pixel groups 10 is arranged in a first direction X and a second direction Y, and each of the plurality of the sub-pixel groups 10 includes two sub-pixels of different colors that are arranged along the first direction X.

In the embodiment, the plurality of the scanning line groups 20 are arranged along the second direction Y. Each of the plurality of the scanning line groups 20 includes a first scanning line Scan 1 and a second scanning line Scan 2 respectively extending along the first direction X. The first scanning line Scan 1 and the second scanning line Scan 2 are disposed on opposite sides of a corresponding row of the plurality of sub-pixel groups 10. The first scanning line Scan 1 is connected to one of the two sub-pixels of each sub-pixel group 10 in the corresponding row, and the second scanning line Scan 2 is connected to the other one of the two sub-pixels of each sub-pixel group 10 in a same or different row.

In the embodiment, the plurality of the data lines Data extend along the second direction Y and are disposed between two adjacent columns of the plurality of sub-pixel groups 10, and each data line is connected to one of the two sub-pixels of each sub-pixel group 10 in the two adjacent columns.

In the embodiment, each of the plurality of data lines Data is connected to respective sub-pixels of a same color, and two adjacent ones of the plurality of data lines are connected to respective sub-pixels of different colors.

By connecting each of the plurality of data lines Data in a DLS pixel architecture to sub-pixels of the same color in the present application, when each of the scanning lines is scanning line by line, the sub-pixels of the same color connected to a same one of the plurality of data lines Data are sequentially turned on. Although the charging time of the sub-pixels is reduced, there is no color mixing issue since the turned-on sub-pixels are of the same color, thereby improving display effect of the display panel 100.

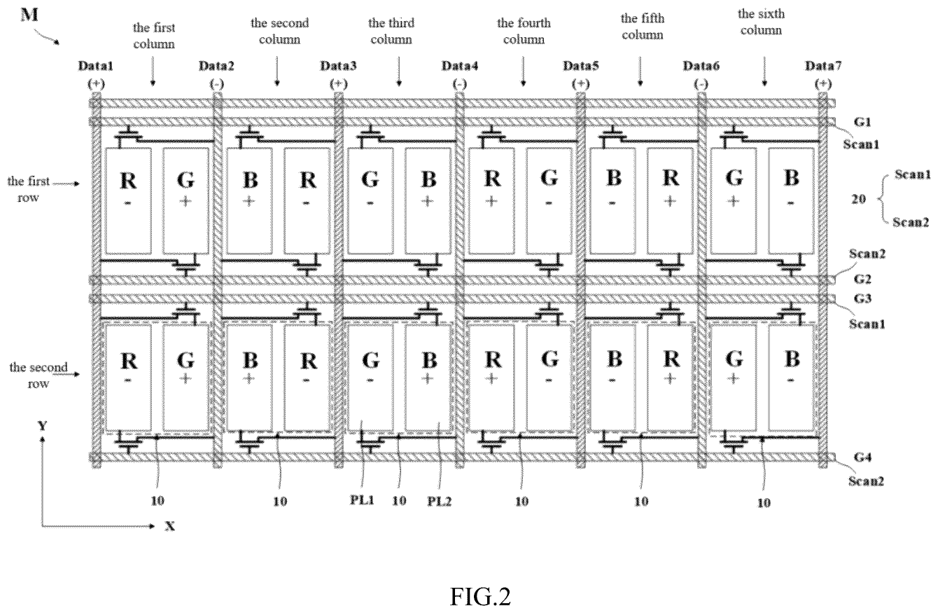

It should be noted that the display panel 100 in the present application may include one or more red sub-pixel R, one or more green sub-pixel G, and one or more blue sub-pixels B, and each of the plurality of sub-pixel groups 10 may include two different ones of a red sub-pixel R, a green sub-pixel G, and a blue sub-pixel B. For example, as shown in FIGS. 2 to 5, the red sub-pixel R, the green sub-pixel G, and the blue sub-pixel B are arranged repeatedly in the first direction X, and the color of the sub-pixels in each column is same, and part of the sub-pixel groups 10 include a red sub-pixel R and a green sub-pixel G arranged along the first direction X, part of the sub-pixel groups 10 include a blue sub-pixel B and a red sub-pixel R arranged along the first direction X, and part of the sub-pixel groups 10 include a green sub-pixel G and a blue sub-pixel B respectively arranged along the first direction X.

It should be noted that two sides of each row of the plurality of the sub-pixel groups 10 are provided with one first scanning line Scan 1 and one second scanning line Scan 2, respectively, that is, one first scanning line Scan 1 and one second scanning line Scan 2 are disposed between two adjacent rows of the plurality of the sub-pixel groups 10.

It should be noted that the first scanning line Scan 1 and the second scanning line Scan 2 respectively extend along the first direction X, and each of the plurality of date lines Data extends along the second direction Y. An included angle between the first direction X and the second direction Y may be greater than 0 and less than or equal to 90 degrees. For example, the included angle between the first direction X and the second direction Y in the present application may be 90 degrees.

It should be noted that polarities of two adjacent ones of the plurality of data lines are opposite, and polarities of two sub-pixels in each of the plurality of sub-pixel groups 10 are opposite. Polarities of the sub-pixels located on two sides of each of the plurality of data lines Data and adjacent to each of the plurality of data lines Data are the same, and the polarities of the sub-pixels on two sides of each of the plurality of the data lines Data are opposite to the polarity of the corresponding one of the plurality of the data lines Data. For example, in the structure shown in FIG. 2, the polarities of the two sub-pixels in each of the sub-pixel groups 10 are positive and negative, respectively. The polarities of the sub-pixels on two sides of a data line Data that transmits a positive polarity signal are negative, and the polarities of the sub-pixels on two sides of a data line Data that transmits a negative polarity signal are positive.

It should be noted that each of the sub-pixels is provided with a thin film transistor. The thin film transistor may be of a etch barrier type or a back channel etch type, or may be classified as a structure of a bottom gate thin film transistor or a top gate thin film transistor according to positions of the gate and the active layer, etc., which is not specifically limited by the present application.

The technical proposal of the present application will now be described in conjunction with specific embodiments.

Referring to FIGS. 2 to 5, an arrangement of the sub-pixels in the present application is a standard RGB arrangement, that is, the red sub-pixel R, green sub-pixel G, and blue sub-pixel B are repeatedly arranged in the first direction X, and colors of the sub-pixels in each column are same.

In an embodiment, the positions of sub-pixels connected to two adjacent first scanning lines Scan1 are different within respective sub-pixel groups 10, and the positions of sub-pixels connected to two adjacent second scanning lines Scan2 are different within respective sub-pixel groups 10.

Referring to FIG. 2, each of the plurality of sub-pixel groups 10 includes a first sub-pixel PL1 and a second sub-pixel PL2 arranged along the first direction X. In one of two adjacent scanning line groups 20, the first scanning line Scan1 is connected to the first sub-pixels PL1 in a row of the sub-pixel groups 10, and the second scanning line Scan2 is connected to the second sub-pixels PL2 in the row of the sub-pixel groups 10. In another one of the two adjacent scanning line groups 20, the first scanning line Scan1 is connected to the second sub-pixels PL2 in another row of the sub-pixel groups 10, and the second scanning line Scan2 is connected to the first sub-pixels PL1 in the another row of the sub-pixel groups 10.

The sub-pixel groups 10 in the first row and second row is taken as an example for the following description.

In a structure as shown in FIG. 2, the first sub-pixel PL1 in the sub-pixel group 10 of the first row and first column is connected to the first scanning line Scan1 of the scanning line group 20 in the first row and the second data line Data2. The second sub-pixel PL2 in the sub-pixel group 10 of the first row and second column is connected to the second scanning line Scan 2 of the scanning line group 20 in the first row and the second data line Data2. The first sub-pixel PL1 in the sub-pixel group 10 of the second row and first column is connected to the second scanning line Scan 2 of the scanning line group 20 in the second row and the second data line Data2. The second sub-pixel PL2 in the sub-pixel group 10 of the second row and second column is connected to the first scanning line Scan 1 of the scanning line group 20 in the second row and the second data line Data2.

That is, in the structure as shown in FIG. 2, firstly, the first scanning line Scan1 of the scanning line group 20 in the first row outputs an active voltage level, the transistor in the first sub-pixel PL1 of the sub-pixel group 10 in the first row and first column is turned on, and the second data line Data2 inputs a data signal to the first sub-pixel PL1 of the sub-pixel group 10 in the first row and first column. Secondly, the second scanning line Scan2 of the scanning line group 20 in the first row outputs the active voltage level, the transistor in the second sub-pixel PL2 of the sub-pixel group 10 in the first row and second column is turned on, and the second data line Data2 inputs the data signal to the second sub-pixel PL2 of the sub-pixel group 10 in the first row and second column. Thirdly, the first scanning line Scan1 of the scanning line group 20 in the second row outputs the active voltage level, the transistor in the second sub-pixel PL2 of the sub-pixel group 10 in the second row and second column is turned on, and the second data line Data2 inputs the data signal to the second sub-pixel PL2 of the sub-pixel group 10 in the second row and second column. Finally, the second scanning line Scan2 of the scanning line group 20 in the second row outputs the active voltage level, the transistor in the first sub-pixel PL1 of the sub-pixel group 10 in the second row and first column is turned on, and the second data line Data2 inputs the data signal to the first sub-pixel PL1 of the sub-pixel group 10 in the second row and first column.

In this embodiment, the sub-pixels connected to the second data line Data2 are red sub-pixels R, the sub-pixels connected to the third data line Data3 are blue sub-pixels B, the sub-pixels connected to the fourth data line Data4 are green sub-pixels G, and the sub-pixels connected to the fifth data line Data5 are the red sub-pixels R, and followed by analogy.

It should be noted that, since the left side of the first data line Data1 is not provided with sub-pixels, the first data line Data1 in the present application is merely connected to the second sub-pixel PL2 in each of the sub-pixel groups 10 of the first column, that is, the first data line Data1 is merely connected to the green sub-pixel G in each of the sub-pixel groups 10 of the first column.

Similarly, in the structure as shown in FIG. 2, the first scanning line Scan1 of the scanning line group 20 in the first row is connected to the first sub-pixel PL1 on the left side of corresponding sub-pixel groups 10, and the second scanning line Scan2 of the scanning line group 20 in the first row is connected to the second sub-pixel PL2 on the right side of the corresponding sub-pixel groups 10. The first scanning line Scan1 of the scanning line group 20 in the second row is connected to the second sub-pixel PL2 on the right side of corresponding sub-pixel groups 10, and the second scanning line Scan2 of the scanning line group 20 second row is connected to the first sub-pixel PL1 on the left side of the corresponding sub-pixel group 10. Similarly, in FIG. 2, the connection modes of the first scanning line Scan1 and second scanning line Scan2 for the odd-numbered rows of scanning line groups 20 are the same, and the connection modes of the first scanning line Scan1 and the second scanning line Scan2 for the even-numbered rows of scanning line groups 20 are the same, and the connection modes for the odd-numbered rows of scanning line groups 20 are different from the manners of connection of the even-numbered row scanning line groups 20.

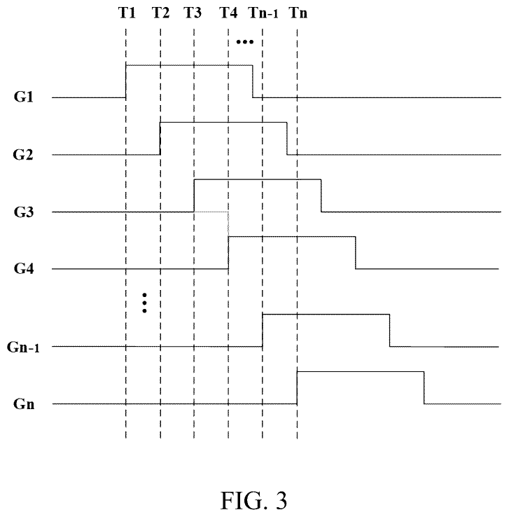

Referring to FIGS. 2 and 3, for two adjacent ones of the plurality of scanning line groups 20, in a scan cycle, the first scanning line Scan1 of the scanning line group 20 of the present stage, the second scanning line Scan2 of the scanning line group 20 of the present stage, the first scanning line Scan1 of the scanning line group 20 of a next stage, the second scanning line Scan2 of the scanning line group 20 of the next stage sequentially input the active scan signals to the sub-pixels of the corresponding rows.

Referring to FIGS. 2 and 3, in the present application, the first scanning line Scan1 of the scanning line group 20 in the first row is referred to as the first scanning line G1, and the moment when the first scanning line G1 inputs the scan signal to the corresponding row of sub-pixels is T1. The second scanning line Scan2 of the scanning line group 20 in the first row is referred to as the second scanning line G2, and the moment when the second scanning line G2 inputs the scan signal to the corresponding row of sub-pixels is T2. The first scanning line Scan1 of the scanning line group 20 in the second row is referred to as the third scanning line G3, and the moment when the third scanning line G3 inputs the scan signal to the corresponding row of sub-pixels is T3. The second scanning line Scan2 of the scanning line group 20 in the second row is referred to as the fourth scanning line G4, and the moment when the fourth scanning line G4 inputs the scan signal to the corresponding row of sub-pixels is T4. A value of T1 is smaller than a value of T2, the value of T2 is smaller than a value of T3, and the value of T3 is smaller than a value of T4, that is, the scanning lines in the structure shown in FIG. 2 perform a progressive scan.

The moment when the (n−1)-th scanning line Gn−1 inputs the scan signal to the sub-pixels of the corresponding row is Tn−1, and the moment when the n-th scanning line Gn inputs the scan signal to the sub-pixels of the corresponding row is Tn, and Tn−1 is smaller than Tn.

In another embodiment, the positions of the sub-pixels connected to two adjacent first scanning lines Scan1 are the same within respective sub-pixel groups, and the positions of the sub-pixels connected to two adjacent second scanning lines Scan2 are the same within respective sub-pixel groups.

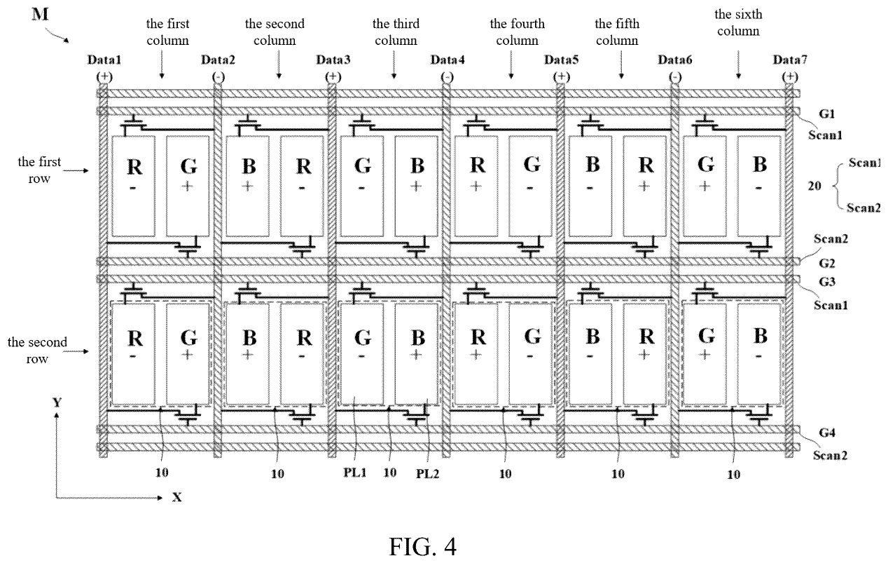

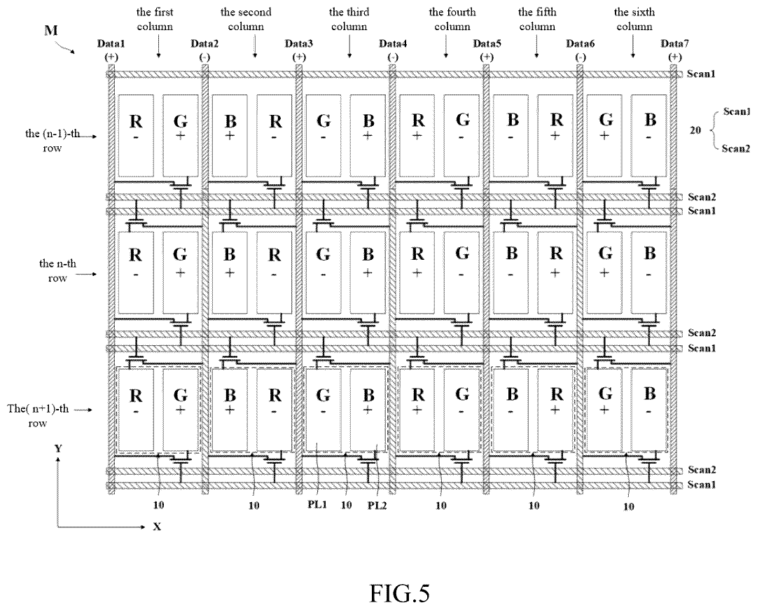

Referring to FIGS. 4 and 5, in each of the two adjacent ones of the plurality of scanning line groups 20, the first scanning line Scan1 is connected to one of the first sub-pixel PL1 and the second sub-pixel PL2 in a corresponding row of the sub-pixel groups 10, and the second scanning line Scan2 is connected to the other one of the first sub-pixel PL1 and the second sub-pixel PL2 in the corresponding row of the sub-pixel groups 10.

The technical proposal of FIG. 4 is described by taking the sub-pixel groups 10 in the first row and second row as an example.

In a structure as shown in FIG. 4, the first sub-pixel PL1 in the sub-pixel group 10 of the first row and first column is connected to the first scanning line Scan1 of the scanning line group 20 in the first row and the second data line Data2. The second sub-pixel PL2 in the sub-pixel group 10 of the first row and second column is connected to the second scanning line Scan 2 of the scanning line group 20 in the first row and the second data line Data2. The first sub-pixel PL1 in the sub-pixel group 10 of the second row and first column is connected to the first scanning line Scan 1 of the scanning line group 20 in the second row and the second data line Data2. The second sub-pixel PL2 in the sub-pixel group 10 of the second row and second column is connected to the second scanning line Scan 2 of the scanning line group 20 in the second row and the second data line Data2.

That is, in the structure as shown in FIG. 4, firstly, the first scanning line Scan1 of the scanning line group 20 in the first row outputs an active voltage level, the transistor in the first sub-pixel PL1 of the sub-pixel group 10 in the first row and first column is turned on, and the second data line Data2 inputs a data signal to the first sub-pixel PL1 of the sub-pixel group 10 in the first row and first column. Secondly, the second scanning line Scan2 of the scanning line group 20 in the first row outputs the active voltage level, the transistor in the second sub-pixel PL2 of the sub-pixel group 10 in the first row and second column is turned on, and the second data line Data2 inputs the data signal to the second sub-pixel PL2 of the sub-pixel group 10 in the first row and second column. Thirdly, the first scanning line Scan1 of the scanning line group 20 in the second row outputs the active voltage level, the transistor in the first sub-pixel PL1 of the sub-pixel group 10 in the second row and first column is turned on, and the second data line Data2 inputs the data signal to the first sub-pixel PL1 of the sub-pixel group 10 in the second row and first column. Finally, the second scanning line Scan2 of the scanning line group 20 in the second row outputs the active voltage level, the transistor in the second sub-pixel PL2 of the sub-pixel group 10 in the second row and first column is turned on, and the second data line Data2 inputs the data signal to the second sub-pixel PL2 of the sub-pixel group 10 in the second row and second column.

In the structure as shown in FIG. 4, the first scanning lines Scan1 in the scanning line groups 20 of the first row and the second row are respectively connected to the first sub-pixels PL1 on the left side of the corresponding sub-pixel groups 10, and the second scanning lines Scan2 in the scanning line groups 20 of the first row and the second row are respectively connected to the second sub-pixels PL2 on the right side of the corresponding sub-pixel groups 10. That is, the connection modes of the first scanning line Scan1 and the second scanning line Scan2 for the scanning line groups 20 of the odd-numbered rows and even-numbered rows in FIG. 4 are the same.

In this embodiment, since the left side of the first data line Data1 is not provided with the sub-pixels, the first data line Data1 in the present application is merely connected to the second sub-pixels PL2 in the sub-pixel groups 10 in the first column, that is, the first date line Data 1 is merely connected to the green sub-pixel G in the sub-pixel groups 10 in the first column, the sub-pixels connected to the second data line Data2 are red sub-pixels R, the sub-pixels connected to the third data line Data3 are blue sub-pixels B, the sub-pixels connected to the fourth data line Data4 are green sub-pixels G, and the sub-pixels connected to the fifth data line Data5 are red sub-pixels R, and followed by analogy.

In yet another embodiment, the display panel 100 includes N rows of sub-pixel groups 10 and N scanning line groups corresponding to the N rows of sub-pixel groups 10, a value of N and a value of n described hereinafter are positive integers, and the value of n is less than or equal to the value of N.

In this embodiment, the first scanning line Scan1 in the n-th scanning line group is connected to the first sub-pixels PL1 in the (n−1)-th row of sub-pixel groups 10, and the second scanning line Scan2 in the n-th scanning line group is connected to the second sub-pixels PL2 in the (n+1)-th row of sub-pixel groups 10. Alternatively, the first scanning line Scan1 in the n-th scanning line group may be connected to the second sub-pixels PL2 in the (n−1)-th row of sub-pixel groups 10, and the second scanning line Scan2 in the n-th scanning line group maybe connected to the first sub-pixels PL1 in the (n+1)-th row of sub-pixel groups 10.

The technical proposal of FIG. 5 is described by taking the sub-pixel groups 10 in the (n−1)-th row to the (n+1)-th row as an example.

In a structure as shown in FIG. 5, the first sub-pixel PL1 in the sub-pixel group 10 of the n-th row and first column is connected to the second scanning line Scan2 of the (n−1)-th row of scanning line group 20 and the second data line Data2. The second sub-pixel PL2 in the sub-pixel group 10 of the n-th row and second column is connected to the first scanning line Scan 1 of the (n+1)-th row of scanning line group 20 and the second data line Data2. The first sub-pixel PL1 in the sub-pixel group 10 of the (n+1)-th row and first column is connected to the second scanning line Scan 2 of the n-th row of scanning line group 20 and the second data line Data2. The second sub-pixel PL2 in the sub-pixel group 10 of the (n+1)-th row and second column is connected to the first scanning line Scan 1 of the (n+2)-th row of scanning line group 20 and the second data line Data2.

That is, in the structure as shown in FIG. 5, the second scanning line Scan2 in the (n−1)-th row of scanning line group 20 outputs an active voltage level, the transistor in the first sub-pixel PL1 of the sub-pixel group 10 in the n-th row and first column is turned on, and the second data line Data2 inputs the data signal to the first sub-pixel PL1 of the sub-pixel group 10 in the first row and first column. Secondly, the first scanning line Scan1 in the (n+1)-th row of scanning line group 20 outputs the active voltage level, the transistor in the second sub-pixel PL2 of the sub-pixel group 10 in the n-th row and second column is turned on, and the second data line Data2 inputs the data signal to the second sub-pixel PL2 of the sub-pixel group 10 in the first row and second column.

In the structure as shown in FIG. 5, the first scanning line Scan1 in each row of the scanning line group 20 is connected to the second sub-pixels PL2 on the right side in the corresponding sub-pixel groups 10 of a previous row, and the second scanning line Scan2 in each row of the scanning line group 20 is connected to the first sub-pixels PL1 on the left side in the corresponding sub-pixel groups 10 of the next row.

It should be noted that the timing diagram in FIG. 3 is further applicable to the structures in FIG. 4 and FIG. 5.

In the DLS pixel architecture as shown in FIG. 2, FIG. 4, and FIG. 5 of the present application, different degrees of feed-through effect occur due to the differences in parasitic capacitance between sub-pixels, the sub-pixels may exhibit a problem of uneven brightness and darkness due to the different degrees of feed-through effect, thereby posing the risk of head-shaking patterns.

In the structure of FIG. 2, when the first scanning line Scan1 of the scanning line group 20 in the first row transmits the active voltage level, a coupling capacitance is formed between the red sub-pixel R in the sub-pixel group 10 of the first row and first column and the first scanning line Scan1 of the scanning line group 20 in the first row, and a first feed-through effect occurs in the red sub-pixel R. When the second scanning line Scan2 of the scanning line group 20 in the first row transmits the active voltage level, the coupling capacitance is between the red sub-pixel R in the sub-pixel group 10 of the first row and first column and the second scanning line Scan2 of the scanning line group 20 in the first row, and the second feed-through effect occurs in the red sub-pixel R.

In the structure as shown in FIG. 2, when the first scanning line Scan1 of the scanning line group 20 in the first row transmits the active voltage level, the green sub-pixel G in the sub-pixel group 10 of the first row and first column is not turned on, and the coupling capacitance is not formed between the green sub-pixel G and the first scanning line Scan1 of the scanning line group 20 in the first row. When the second scanning line Scan2 of the scanning line group 20 in the first row transmits the active voltage level, the green sub-pixel G in the sub-pixel group 10 of the first row and first column is turned on, and the coupling capacitance is formed between the green sub-pixel G and the second scanning line Scan2 of the scanning line group 20 in the first row, the first feed-through effect occurs in the green sub-pixel G.

In the structure as shown in FIG. 2, when the first scanning line Scan1 of the scanning line group 20 in the second row transmits the active voltage level, the coupling capacitance exists between the green sub-pixel G in the sub-pixel group 10 of the second row and first column and the first scanning line Scan1 of the scanning line group 20 in the second row, and the first feed-through effect occurs in the green sub-pixel G. When the second scanning line Scan2 of the scanning line group 20 in the second row transmits the active voltage level, the coupling capacitance is formed between the green sub-pixel G in the sub-pixel group 10 of the second row and first column and the second scanning line Scan2 of the scanning line group 20 in the second row, and a second feed-through effect occurs in the green sub-pixel G.

In the structure as shown in FIG. 2, when the first scanning line Scan1 of the scanning line group 20 in the second row transmits the active voltage level, the red sub-pixel R in the sub-pixel group 10 of the second row and first column is not turned on, and the coupling capacitance is not formed between the red sub-pixel R and the first scanning line Scan1 of the scanning line group 20 in the first row. When the second scanning line Scan2 of the scanning line group 20 in the second row transmits the active voltage level, the red sub-pixel R in the sub-pixel group 10 of the second row and first column is turned on, and the coupling capacitance is formed between the red sub-pixel R and the second scanning line Scan2 of the scanning line group 20 in the second row, and the first feed-through effect occurs in the red sub-pixel R.

In the structure as shown in FIG. 2, for the sub-pixels of the same color in the same column, the numbers of times the feed-through effects occur in two adjacent sub-pixels are different. The Sub-pixel with the feed-through effect occurring once and the sub-pixel the feed-through effect occurring twice are disposed alternately. A data line Data of the present application is connected to two adjacent columns of sub-pixels of a same color. The degree of feed-through effect occurring in sub-pixels of the same color is equivalent, which enhances the brightness uniformity of the two adjacent columns of sub-pixels of the same color and improves the display effect of the display panel 100.

In the structure as shown in FIG. 5, since the sub-pixels in the sub-pixel groups 10 are connected to the scanning lines of the adjacent rows, the coupling capacitance is not formed between the sub-pixels and connected scanning lines thereof. Therefore, the feed-through effect does not occur in the sub-pixels shown in FIG. 5.

The present application further provides a display device that includes a terminal body and the display panel described above, and the terminal body and the display panel are combined into one unit. The terminal body may include devices such as a circuit board bound to the display panel, and a cover plate disposed on the display panel, etc. The mobile terminal may include electronic apparatus such as a mobile phone, a television, a notebook computer, etc.

In the description of the present application, the terms “first” and “second” are used solely for descriptive purposes and should not be understood to imply relative importance or implicitly specify the number of technical features indicated. Thereby, a feature defined as “first” or “second” may include one or more features explicitly or implicitly. In the description of the present application, “a plurality” means two or more, and “at least one” means one, two, or more, unless otherwise specifically defined.

In the above embodiments, each embodiment focuses on various aspects. For parts not described in detail in an embodiment, please refer to the relevant descriptions of other embodiments.

In the present application, the embodiments, implementation methods, and related technical features can be combined and substituted with each other without conflict.

The above is merely a preferred embodiment of the present application and does not impose any form of limitation on it. Any simple modifications, equivalent changes, and embellishments made to the above embodiment based on the technical essence of the present application, without deviating from the content of the technical proposal of the present application, shall still fall within the scope of the technical proposal of the present application.

What is claimed is:

1. A display panel, comprising□
a plurality of sub-pixel groups arranged along a first direction and a second direction, each of the plurality of sub-pixel groups comprising two sub-pixels of different colors arranged along the first direction;
a plurality of scanning line groups arranged along the second direction, each of the plurality of scanning line groups comprising a first scanning line and a second scanning line respectively extending along the first direction, and the first scanning line and the second scanning line being disposed on two sides of a corresponding row of the sub-pixel groups, and the first scanning line being connected to one of the two sub-pixels of each of the sub-pixel groups in one row, and the second scanning line being connected to the other one of the two sub-pixels of each of the sub-pixel groups in a same or a different one row; and
a plurality of data lines extending along the second direction, and each of the plurality of data lines being arranged between two adjacent columns of the sub-pixel groups, and each of the plurality of data lines being connected to one of the two sub-pixels of each of the sub-pixel groups in the two adjacent columns;
wherein each of the plurality of data lines is connected to respective sub-pixels of a same color, and two adjacent ones of the plurality of data lines are connected to respective sub-pixels of different colors.

2. The display panel according to claim 1, wherein positions of the sub-pixels connected to two adjacent ones of a plurality of first scanning lines are different within respective sub-pixel groups, and positions of the sub-pixels connected to two adjacent ones of a plurality of second scanning lines are different within respective sub-pixel groups.

3. The display panel of claim 2, wherein each of the plurality of sub-pixel groups comprises a first sub-pixel and a second sub-pixel arranged along the first direction;
wherein in one of adjacent two of the plurality of scanning line groups, the first scanning line is connected to the first sub-pixel of each of the sub-pixel groups in a corresponding one row, and the second scanning line is connected to the second sub-pixel of each of the sub-pixel groups in the corresponding one row; and
wherein in the other one of the adjacent two of the plurality of scanning line groups, the first scanning line is connected to the second sub-pixel of each of the sub-pixel groups in another corresponding one row, and the second scanning line is connected to the first sub-pixel of each of the sub-pixel groups in the another corresponding one row.

4. The display panel according to claim 3, wherein for the adjacent two of the plurality of scanning line groups, within a scan cycle, the first scanning line of one of the adjacent two of the plurality of scanning line groups of a present stage, the second scanning line of the one of the adjacent two of the plurality of scanning line groups of the present stage, the first scanning line of the other one of the adjacent two of the plurality of scanning line groups of a next stage, and the second scanning line of the other one of the adjacent two of the plurality of scanning line groups of the next stage sequentially input scan signals to the sub-pixels of corresponding rows.

5. The display panel according to claim 1, wherein positions of the sub-pixels connected to two adjacent ones of a plurality of first scanning lines are the same within respective sub-pixel groups, and positions of the sub-pixels connected to two adjacent ones of a plurality of second scanning lines are the same within respective sub-pixel groups.

6. The display panel according to claim 5, wherein each of the plurality of sub-pixel groups comprises a first sub-pixel and a second sub-pixel arranged along the first direction; and
in adjacent two of the plurality of scanning line groups, the first scanning line in both scanning line groups is respectively connected to one of the first sub-pixel and the second sub-pixel of each of the sub-pixel groups in corresponding rows, and the second scanning line in the both scanning line groups is respectively connected to the other one of the first sub-pixel and the second sub-pixel of each of the sub-pixel groups in corresponding rows.

7. The display panel according to claim 6, wherein the display panel comprises N rows of the sub-pixel groups and N scanning line groups corresponding to the N rows of the sub-pixel groups; and
wherein the first scanning line in an n-th scanning line group is connected to one of the first sub-pixel and the second sub-pixel in an (n−1)-th row of the sub-pixel groups, the second scanning line in the n-th scanning line group is connected to the other one of the first sub-pixel and the second sub-pixel in an (n+1)-th row of the sub-pixel groups, values of N and n are positive integers, and the value of n is less than or equal to the value of N.

8. The display panel according to claim 1, wherein polarities of two adjacent ones of the plurality of data lines are opposite, and polarities of the two sub-pixels in each of the plurality of sub-pixel groups are opposite.

9. The display panel according to claim 2, wherein polarities of two adjacent ones of the plurality of data lines are opposite, and polarities of the two sub-pixels in each of the plurality of sub-pixel groups are opposite.

10. The display panel according to claim 3, wherein polarities of two adjacent ones of the plurality of data lines are opposite, and polarities of the two sub-pixels in each of the plurality of sub-pixel groups are opposite.

11. The display panel according to claim 4, wherein polarities of two adjacent ones of the plurality of data lines are opposite, and polarities of the two sub-pixels in each of the plurality of sub-pixel groups are opposite.

12. The display panel according to claim 5, wherein polarities of two adjacent ones of the plurality of data lines are opposite, and polarities of the two sub-pixels in each of the plurality of sub-pixel groups are opposite.

13. The display panel according to claim 6, wherein polarities of two adjacent ones of the plurality of data lines are opposite, and polarities of the two sub-pixels in each of the plurality of sub-pixel groups are opposite.

14. The display panel according to claim 7, wherein polarities of two adjacent ones of the plurality of data lines are opposite, and polarities of the two sub-pixels in each of the plurality of sub-pixel groups are opposite.

15. The display panel according to claim 8, wherein polarities of the sub-pixels located on two sides of each of the data lines and disposed adjacent to each of the data lines are the same, and the polarities of the sub-pixels located on the two sides of each of the data lines are opposite to a polarity of a corresponding one of the plurality of data lines.

16. The display panel according to claim 9, wherein polarities of the sub-pixels located on two sides of each of the data lines and disposed adjacent to each of the data lines are the same, and the polarities of the sub-pixels located on the two sides of each of the data lines are opposite to a polarity of a corresponding one of the plurality of data lines.

17. The display panel according to claim 10, wherein polarities of the sub-pixels located on two sides of each of the data lines and disposed adjacent to each of the data lines are the same, and the polarities of the sub-pixels located on the two sides of each of the data lines are opposite to a polarity of a corresponding one of the plurality of data lines.

18. The display panel according to claim 11, wherein polarities of the sub-pixels located on two sides of each of the data lines and disposed adjacent to each of the data lines are the same, and the polarities of the sub-pixels located on the two sides of each of the data lines are opposite to a polarity of a corresponding one of the plurality of data lines.

19. The display panel according to claim 12, wherein polarities of the sub-pixels located on two sides of each of the data lines and disposed adjacent to each of the data lines are the same, and the polarities of the sub-pixels located on the two sides of each of the data lines are opposite to a polarity of a corresponding one of the plurality of data lines.

20. A display device, wherein the display device comprises the display panel, and the display panel comprises:
a plurality of sub-pixel groups arranged along a first direction and a second direction, each of the plurality of sub-pixel groups comprising two sub-pixels of different colors arranged along the first direction;
a plurality of scanning line groups arranged along the second direction, each of the plurality of scanning line groups comprising a first scanning line and a second scanning line respectively extending along the first direction, and the first scanning line and the second scanning line being disposed on two sides of a corresponding row of the sub-pixel groups, and the first scanning line being connected to one of the two sub-pixels of each of the sub-pixel groups in one row, and the second scanning line being connected to the other one of the two sub-pixels of each of the sub-pixel groups in a same or a different one row; and
a plurality of data lines extending along the second direction, and each of the plurality of data lines being arranged between two adjacent columns of the sub-pixel groups, and each of the plurality of data lines being connected to one of the two sub-pixels of each of the sub-pixel groups in the two adjacent columns;
wherein each of the plurality of data lines is connected to respective sub-pixels of a same color, and two adjacent ones of the plurality of data lines are connected to respective sub-pixels of different colors.
